(19) United States
(12) Patent Application Publication
(10) Pub. No.: US 2007/0263612 A1
(43) Pub. Date: Nov. 15, 2007

(54) Packet-switched network telephone system with enhanced portability

(75) Inventor: Michael Ke Zhao, Qingdao (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/471,162

(22) Filed: Jun. 20, 2006

(30) Foreign Application Priority Data
Mar. 31, 2006 (CN) 200610071049.1

(51) Int. Cl. H04L 12/66

(52) U.S. Cl. 370/356

(57) ABSTRACT

A packet-switched network telephone system includes at least one set of telephone equipment adapted for connection with the packet-switched network and electronic registration upon connection, wherein the electronic registration is based on registration information stored on a portable data storage device. The portable data storage device includes a data storage medium, and the registration information stored on the data storage medium. A data reading device includes a data reading means for obtaining the registration information from the portable data storage device, and a data communication means for communicating the registration information to the at least one set of telephone equipment.

This application is entitled to the benefit of and claims foreign priority under 35 U.S.C. § 119 from Chinese Patent Application No. 200610071049.1, filed Mar. 31, 2006, the disclosure of which is hereby incorporated by reference.

### FIELD OF THE INVENTION

The present invention relates to telephone communications over a packet-switched network.

### BACKGROUND OF THE INVENTION

The Public Switched Telephone Network (PSTN) is formed from the circuit switched telephone networks interconnected throughout the world. In a circuit switched network, one or more continuous telephone circuits are established for a telephone call between two or more users. The same circuit or circuits are maintained for the duration of the call. By way of illustration, the following describes a simplified process by which a first user places a telephone call to a second user over the PSTN.

For the first user on the PSTN to make a call to the second user, the first user, using the first user's telephone equipment, dials the second user's telephone number. Various, well-known analog and/or digital switching and routing equipment within the PSTN will then locate the second user's telephone line, which is associated with the second user's telephone number, establish a circuit between the first and second users' respective telephone lines, and using the circuit so established, transmit a ringing signal to the second user's telephone equipment, as well as an indication of first user's telephone number. As a result, the second user's telephone equipment will ring to indicate the incoming call. If the second user's telephone service includes widely available caller identification functionality, and the second user's telephone equipment is adapted to display caller identification data, the second user's telephone equipment will also display the first user's telephone number. The second user answers the call, or “picks up,” using the second user's telephone equipment, and the circuit between the first and second users is maintained until one or both users disestablishes the circuit by “hanging up.”

Although there are numerous variations and additional levels of complexity that could be added to the above description of a telephone call on the PSTN, it should be recognized that for calls on the PSTN, telephone numbers are essentially associated with telephone lines. While the association of telephone numbers and lines is not strictly a physical association, and the association is selectively variable, as different, and even multiple, numbers can be associated with a given line, the association is primarily not a function of the user's respective telephone equipment. In the description above, if either or both users connected different telephone equipment to each user's respective telephone lines, it would clearly not alter the process. If the first user's telephone equipment were connected to a different telephone line, a different telephone number would be displayed by the caller identification feature on the second user's telephone. Likewise, if the second user's telephone equipment were connected to a different telephone line, the second user's telephone equipment would not ring when the first user dialed the second user's telephone number.

The developing alternatives to the PSTN largely involve packet-switched network telephone systems utilizing Voice over Internet Protocol (VoIP), also referred to as Internet telephony, in which packet-switched networks are used in lieu of circuit-switched networks for sending voice signals between users. In a packet-switched network, like the Internet, a continuous circuit is not established between users during a telephone call. Instead, a data stream including the voice signal is broken down into a plurality of packets, and each packet is separately routed between the users' respective network addresses, such as Session Initiation Protocol (SIP) addresses, or the like. The packets are then reassembled in the proper order, so the voice signal can be accurately reproduced. Although technically it is possible for all the packets to travel along the same circuit, such an occurrence would be merely coincidental and is extremely unlikely. Thus, in the packet-switched network telephone system context, there are not “telephone lines” with which to associate the respective users' electronic addresses. Instead, a user's electronic address is commonly associated with one or more network hardware components used to connect the user's VoIP telephone equipment to the packet-switched network.

Typically, a network hardware component has a permanently programmed, or “burned-in,” Media Access Control, MAC, or similar hardware address. The SIP address, or other electronic address, is mapped (usually through one or more intermediate addresses) to the network hardware component's MAC address. While this mapping between the electronic address and the hardware address is not permanent, for a given mapping, the network hardware component is ultimately recognized by the MAC address when the network hardware component is connected to the packet-switched network, regardless of the physical location, or connection point of the network hardware.

In locations where the PSTN is the predominant means of telephone access, the network hardware component typically takes the form of a digital phone adapter that interfaces with the user's Internet access hardware, such as a Digital Subscriber Line (DSL), or cable modem. PSTN-compatible telephone equipment is then connectable with the digital phone adapter and can be used in tandem with the digital phone adapter to place and receive calls over a packet-switched network telephone system. In locations where VolP systems are more commonly employed, the network hardware component is often integral with the user's telephone equipment.

To make a VoIP system more closely resemble the PSTN from a user's perspective, telephone numbers are still typically used for making and receiving calls. As a telephone number, by itself, has no significance to the packet-switched network telephone system, the telephone number is mapped to a SIP address, or similar network address, using tElephone NUmber Mapping (ENUM), or a like protocol. The SIP, or similar electronic address, is ultimately mapped to a hardware address of the user's network hardware component, whether a separate digital phone adapter, or integral with the user's telephone equipment. Thus, the user's telephone equipment, including the telephone equipment and the network hardware component, is effectively self-identifying once connected to the packet-switched network. Provided the user's telephone equipment is connected anywhere to the appropriate packet-switched network, calling the user's telephone number will result in “ringing” of the user's telephone. Similarly, telephone calls made with the user's telephone will be associated with the user's telephone number, regardless of where the VoIP telephone equipment is connected.

In a network environment where the user's telephone equipment is connected to the main packet-switched network, such as the Internet, through one or more intermediate network hardware components, such as a DSL or cable modem and a router, some provision is made for the “transparency” of the intermediate components, such that the SIP, or other address, of the telephone equipment is locatable to the main packet-switched network through the intermediate components.

Interoperability between the packet-switched network telephone system with the PSTN is achieved using a PSTN gateway, or similar device, typically operated by a VoIP, or other Internet, service provider. When a VoIP user calls a telephone number of a PSTN user, the packets are routed to the PSTN gateway and a circuit is established between the PSTN gateway and the PSTN user's telephone line, typically via a PSTN network switch. Both the VoIP user's telephone number and the PSTN user's telephone number are communicated to the PSTN switch, so the PSTN user's telephone equipment will display, if properly equipped, the telephone number of the VoIP user. If the PSTN user calls the VoIP user, the PSTN will establish a circuit between the PSTN user's line and the gateway, which the PSTN associates with the VoIP user's telephone number, usually among many other VoIP users' numbers. The gateway will break the necessary information into packets, and provided that the VoIP user's telephone equipment is connected to the packet-switched network, the packets will be routed to the VoIP user's telephone equipment and reassembled.

In some parts of the world, packet-switched network telephone systems are already very common, and as Next Generation Networking (NGN) architecture increasingly utilizes packet-switched networks for telecommunications purposes, packet-switched network telephone systems, and particularly SIP-based VoIP systems, are likely to become more widely accessible.

With the widespread accessibility of such systems, a user can effectively travel with the same telephone number, for call placing and receiving purposes, by taking the same telephone equipment to each location where the ability to place and receive calls is desired, and, at each location, connecting the telephone equipment to the packet-switched network. However, physically transporting the telephone equipment is often burdensome, given, for example, a standard office telephone, or facsimile machine.

Alternately, a user can, at least in theory, travel with the same telephone number without taking the same telephone equipment by re-mapping of the user's telephone number to the telephone equipment at each location. This alternative, requires, among other things, a knowledge of the network hardware address of the telephone equipment at each location, and some other means of access to the packet-switched network to execute the re-mapping.

Also, a user may attempt emulating, or “spoofing,” the hardware address of the telephone equipment at each location to correspond to the hardware address of the user's own telephone equipment. Depending on the telephone equipment, such “spoofing” may not be effective, and still requires the user to possess both a knowledge of the user's own telephone equipment hardware address, and the electronic hardware and software to execute the “spoof.”

From the foregoing, it can be appreciated that there is a need for some means to enable the portability of telephone numbers in a packet-switched network system, while not necessarily requiring the possession of complicated and/or burdensome equipment and particularized knowledge of reprogramming techniques, network addresses, and the like.

### SUMMARY OF THE INVENTION

According to an embodiment of the present invention, a packet-switched network telephone system includes at least one set of telephone equipment adapted for connection with the packet-switched network and electronic registration upon connection, wherein the electronic registration is based on registration information stored on a portable data storage device.

According to another aspect of the present invention, a portable data storage device includes a data storage medium, and registration information stored on the data storage medium.

According to a further aspect of the present invention, a data reading device includes a data reading means for obtaining registration information from a portable data storage device, and a data communication means for communicating the registration information to at least one set of telephone equipment adapted for connection with a packet-switched network.

These and other features and advantages of the present invention will be better appreciated in view of the drawings and the detailed description, below.

### BRIEF DESCRIPTION OF THE DRAWINGS

FIG. 1 is a schematic diagram of a packet-switched network telephone system, according to an embodiment of the present invention;

FIG. 2 is a schematic diagram of a set of telephone equipment included in the telephone system of FIG. 1;

FIG. 3 is a schematic diagram of a set of telephone equipment, according to another embodiment of the present invention;

FIG. 4 is a schematic diagram of a set of telephone equipment, according to a further embodiment of the present invention;

FIG. 5 is a schematic diagram of a system server included in the telephone system of FIG. 1;

FIG. 6 is a schematic diagram of a set of telephone equipment, according to an additional embodiment of the present invention;

FIG. 7 is a schematic diagram of a data reading device, according to another embodiment of the present invention;

FIG. 8 is a schematic diagram of a data reading device and a portable data storage device, according to a further embodiment of the present invention; and

FIG. 9 is a schematic diagram of a data reading device and a portable data storage device, according to an additional embodiment of the present invention.

### DETAILED DESCRIPTION

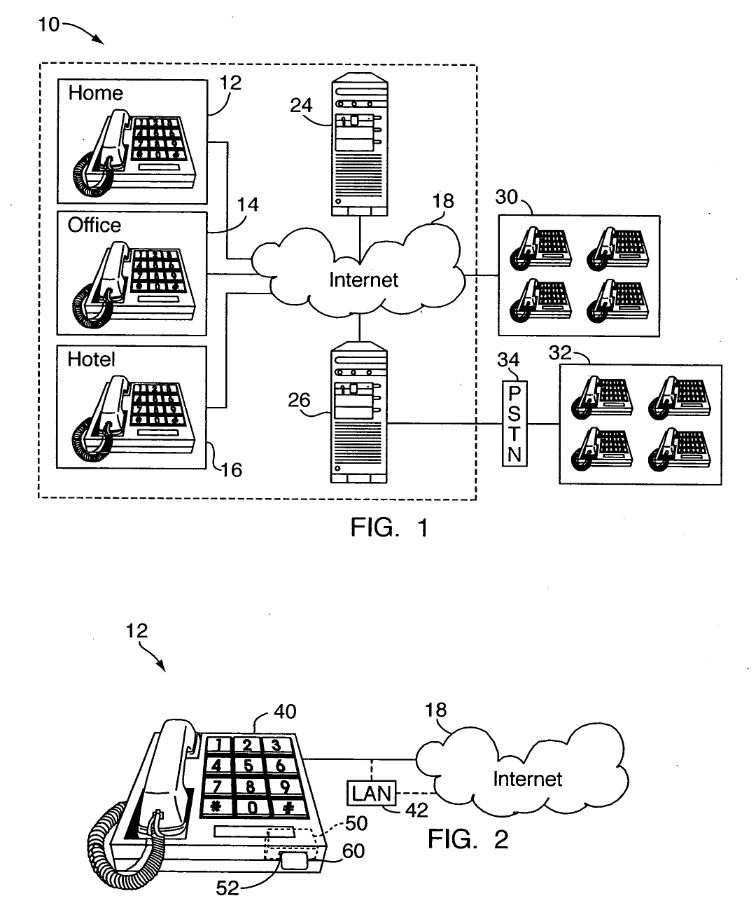

Referring to FIG. 1, a packet-switched network based telephone system 10 includes a plurality of sets of telephone equipment 12-16, each set of telephone equipment 12-16 being connected to a packet-switched network 18, and each set of telephone equipment 12-16 having a different physical location. For instance, the set 12 is located at a first user's home, the set 14 is located at the first user's office, and the set 16 is located at a hotel visited by the first user while traveling on business.

The packet-switched network 18, in the described embodiment, includes the Internet 18. The telephone system 10 further includes a system server 24 and a Public Switched Telephone Network (PSTN) gateway 26. A plurality of other sets of telephone equipment 30 is connected to the telephone system 10 by connection to the Internet 18. Additionally, another plurality of sets of telephone equipment 32 is connectable to the Internet 18 by connection through a circuit-switched telephone network 34, such as the PSTN 34 and the PSTN gateway 26.

Referring to FIG. 2, each set of telephone equipment 12-16 has components including a telephone 40 adapted to connect to the Internet 18, either directly, or through a local area network (LAN) 42. In the embodiment described, each of the sets of telephone equipment 12-16 are substantially similar, so the following description refers to only first user telephone set 12, and alternate embodiments thereof, to avoid redundancy. A data reading device 50 is integral with the telephone 40 and adapted to physically interface, for instance, using a slot 52, with a portable data storage device 60, such as a data card 60. The data reading device 50 includes a data reading means, such as magnetic heads, a connection for accessing semiconductor memory, a laser diode, or the like, depending on a data storage medium of the data card 60. The data reading device 50 also includes a data communication means for communicating the registration information, such as a parallel and/or series port, a hard-wired connection, or the like.

The data card 60 includes data storage medium, such as a magnetic storage medium, a semiconductor storage medium, an optical storage medium, or the like. Encoded in the storage medium of the data card 60 is registration information. The registration information includes a network address, the network address being associated with a first user telephone number, and authentication information. Typically, the network address is associated with the telephone number by an tElephone NUmber Mapping (ENUM) protocol, or the like.

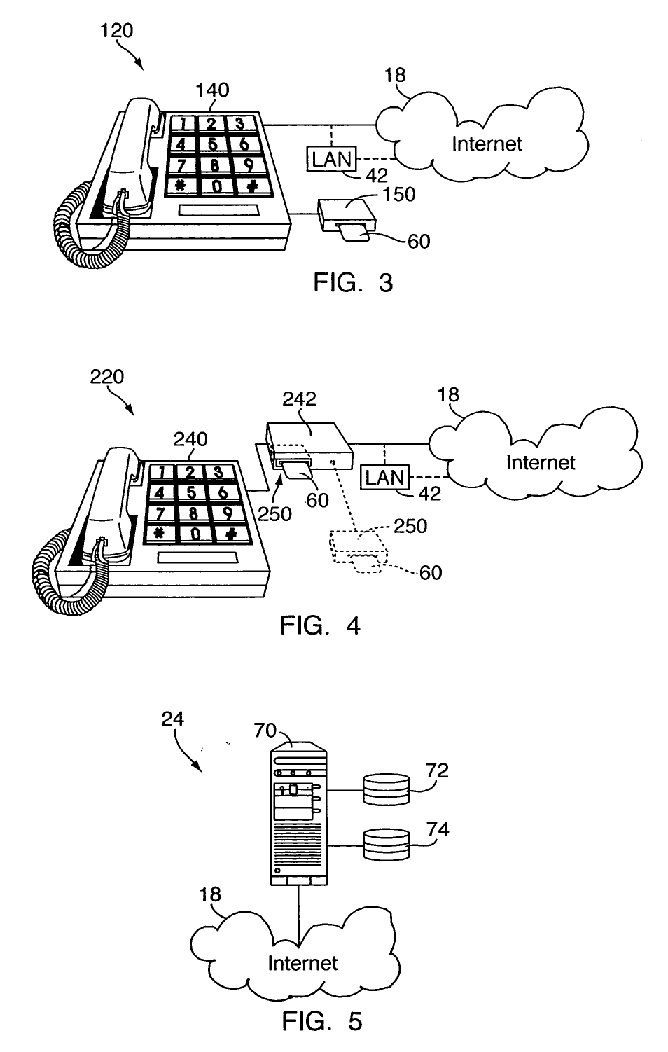

Referring to FIG. 3, a set of telephone equipment 120 can alternatively include a telephone 140, connected to the Internet 18 and to a separate data reading device 150 adapted to physically interface with the data card 60. Referring to FIG. 4, another embodiment of a first user set of telephone equipment 220 includes a PSTN telephone 240 connected to the Internet 18 using a digital phone adapter 242. A data reading device 250 for obtaining the registration information from the data card 60 is integral with the digital phone adapter 242, or alternately, separately connected to the digital phone adapter 242, shown in broken lines.

Referring to FIG. 5, the system server 24 includes a server mainframe 70. The server mainframe 70 is connected to the Internet 18 and also connected with a message database 72 and a billing account database 74.

Referring to FIGS. 1, 2 and 5, in operation, the first user is initially at home, in the vicinity of the first user set of telephone equipment 12. The first user inserts the data card 60 into the slot 52 of the data reading device 50. The data reading device 50 reads the registration information encoded of the data storage medium of the data card 60 and communicates the registration information to the telephone 40. Upon receiving the registration information, telephone 40 electronically registers with the system server 24 through the Internet 18.

During the electronic registration, the network address and the authentication information included in the registration information are used to successfully complete the electronic registration. As a result of the electronic registration with the system server 24, data stream packets from calls made to the first user telephone number will now be routed through the Internet to the first user set of telephone equipment 12, and call made by the first user will from first user set of telephone equipment 12 will be associated with the first user telephone number.

Once the electronic registration is successfully completed, calls the first user makes to and/or receives from the sets of telephone equipment 30, 32, proceed according to the appropriate protocols for the packet-switched network-based telephone system 10, such as a Session Initiation Protocol (SIP). According to such protocols, the first user calls to or from the sets of telephone equipment 30 are typically routed through the Internet, and need not necessarily involve the system server 24, at least not for the entire call, whereas first user calls to or from the sets of telephone equipment 32 must be completed utilizing the PSTN gateway 26, or a similar device.

Electronic registration with the system server 24 also allows the first user to access messages associated with the first user telephone number on the message database 72, i.e., a virtual or “voice” mail box, and allows updating of billing information in the billing account database 74, based on the first user's on-going use of the system, for instance on a per-call, per-minute, or fixed-rate basis. Thus, the data card 60 is enabled to serve as a type of calling card, without necessarily requiring that telephone usage time be paid in advance.

When the first user leaves home, the first user removes the data card 60 from the slot 52. When the data reading device detects that the data card is no longer inserted in the slot 52, the telephone 40 automatically de-registers with the server. As a result, the first user's telephone number will no longer be associated with the set of telephone equipment 12. Calls made to the first user's telephone number when the data card is not inserted to any slot 52 will typically be forwarded to the first user's voice mail box, allowing a message to be recorded for the first user on the message database 72.

The first user, upon arriving at the office, inserts the data card 60 into the data reading device 50 of the set of telephone equipment 14. As with the set of telephone equipment 12, this results in electronic registration with the system server 24 and the association of the first user's telephone number with the set of telephone equipment 14. The first user also has access to the message database 72 and telephone usage by the first user will result in updating of the billing account database 74. Removal of the data card 60 will, similarly with the set of telephone equipment 12, result in de-registration. If the first user is traveling on business, for instance, and stays at the hotel with the set of telephone equipment 16, insertion and subsequent removal of the data card 60 in the data reading device 50 of the telephone equipment 16 will produce the same results.

As can be seen from the foregoing description, the present invention allows for enhanced portability of the first user's telephone number and allows the first user to easily access other telephone services, such as voice mail, from any packet-switched network telephone equipment adapted to receive registration information from the portable data storage device 60. Recipients of calls from the first user, if supplied with telephone equipment equipped with Caller ID, or the like, will always see the first user's telephone number displayed, even though the first user may alternately be at home, the office, the hotel, or some other location having telephone equipment adapted to receive registration information from the portable data storage device 60. Rather than having to use calling cards, or the like, at each location, the present invention allows the first user to be billed on an on-going basis. Unlike the prior art, the present invention enables these, and other, advantages, while not necessarily requiring any particularized knowledge of network addresses and programming procedures, and no equipment beyond the portable data storage device 60.

Those skilled in the art will appreciate that the present invention is not limited to the embodiments described, but that other modifications and variations, and adaptations for circumstances fall within the scope of the present invention.

For instance, the packet-switched network telephone system 10 is described as utilizing the Internet 18. While many packet-switched based telephone systems currently use the Internet, at least in part, the present invention is not limited to such systems. For instance, the present invention can also be advantageously employed in connection with an entirely private packet-switched LAN or Wide-Area Network (WAN), that is not connected to the Internet.

Only one system server 24 and PSTN gateway 26 are shown, but the present invention includes and applies to packet-switched network based telephone systems using multiple proxy servers and PSTN gateways, as well as other system components known to those skilled in the art. Additionally, although system server 24 is shown directly connected to the message database 72 and the billing account database 74, it will be understood that additional databases, corresponding to additional known user phone services, such as concierge-type services, and other administrative and/or accounting functions, are includable. Such databases need not be directly connected with the system server 24 or another proxy server, but can be integral to the server 24, and also accessible through the Internet or other network, for instance.

Although the sets of telephone equipment 30 are shown as not forming a part of the telephone system 10, some or all of the sets 30 can also be part of the same telephone system 10 as the plurality of the first user sets of telephone equipment 12-16.

In the sets of telephone equipment 20, 120 and 220, the telephone 40, 140 or the digital phone adapter 242 are all adapted to electronically register with the system server 24 based on the registration information obtained by the data reading device 50, 150 and 250. Accordingly, the telephone 40, 140 and the digital phone adapter 242 typically have separate connections to the Internet 18 and to the data reading device 50, 150 and 250.

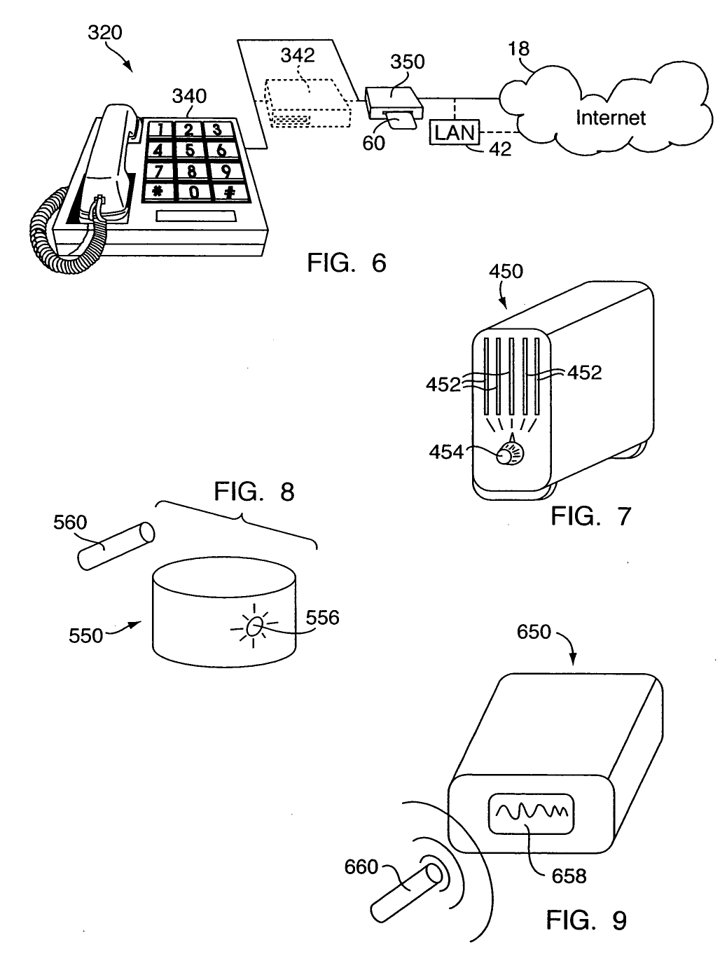

In an alternate embodiment, referring to FIG. 6, a set of telephone equipment 320 includes a telephone 340, connected to a digital phone adapter 342 if the telephone 340 is a PSTN telephone, and a data reading device 350. While the telephone 340, or the digital phone adapter 342 if the telephone 340 is a PSTN telephone, is adapted to electronically register with the system server 24, the telephone 340, or the digital phone adapter 342, is not adapted to electronically register based on the registration information obtained from the data card 60 by the data reading device 350. When the data reading device 350 is inserted between the telephone 340, or the digital phone adapter 342, and the Internet 18, the data reading device 350 is programmed to replace the registration information that would otherwise be communicated to the system server 24 by the telephone 340, or the digital phone adapter 342, with the registration information on the data card 60, using a known “spoofing” or emulation process. Including the data reading device 350 with the telephone equipment 320, permits the telephone equipment 320 to be advantageously employed according to the present invention, without requiring extensive replacement or modification of the telephone 340, or digital phone adapter 342.

Each of the first user sets of telephone equipment 12-16 is described as substantially similar, though a variety of different sets of telephone equipment, such any of the sets 20, 120, 220, and 320, could be substituted. More or fewer sets of telephone equipment could also be included in the telephone system 10. Also, one or more other telephone systems are also includable in the system, typically associated with other service providers and commonly using the Internet 18 together with the telephone system 10. The present invention is further not limited to two-party, voice-only telephone calling, but further encompasses telephone systems providing conference calling, facsimile, video, multi-media, and other known telecommunications services.

In the embodiment described above, the telephone 40 automatically electronically registers with the system server 24 upon receiving the registration information from the data reading device 50. Alternatively, a user command, such a key entry can be required prior to performance of the electronic registration. Similarly, de-registration occurs automatically upon removal of the data card 60, but can occur earlier or later based on another user command. Although, in the embodiment described, authentication information is stored on the data card 60 and automatically communicated to the system server 24, the first user can also be required to enter authentication information, such a Personal Identification (PIN) number, using, for instance, the telephone 40 keypad.

In the described embodiment, the portability of the first user's telephone number and associated telephone services, such as voice mail, is demonstrated in connection with the first user successively using the data card 60 in the plurality of first user sets of telephone equipment 12-16. It will be appreciated that the present invention also allows multiple users similar flexibility to successively use the same set of telephone equipment. For instance, a family of users provided with respective data cards 60, each ultimately associated with a different telephone number, may, by successively inserting the respective data cards 60, receive and make calls on the same set of telephone equipment, and have such calls associated with the currently inserted respective data card 60.

Also, referring to FIG. 7, a data reading device 450 has a plurality of slots 452, allowing each of the family of users to each simultaneously insert a respective data card 60 (not shown) into different slots 452, thereby resulting in telephone calls associated with any of the family's respective telephone numbers to be received on a telephone connected with the data reading device 450. To allow for a distinction to be made between in-coming calls, respective ring-tone information is also stored on the respective data cards 60, resulting in a distinctive ring associated with each telephone number. A selection means 454, such as a knob 454, keypad, switch, or the like, is further provided to allow each user in the family to select which telephone number will be associated with an outgoing call.

The data reading devices 50, 150, 250, 350 and 450 are each adapted to physically interface with the data card 60, for instance by insertion of the data card 60 into the data reading devices. However, within the scope of the present invention, other combinations of portable data storage devices and data reading devices are employable. For example, referring to FIG. 8, the portable data storage device 560 includes an active or passive Radio Frequency IDentification (RFID) tag, or other transponder device, detectable by an RFID reader included in the data reading device 550. To indicate that the RFID tag within the portable data storage device 560 has been read, the data reading device includes a visual indicator 556. Alternatively, referring to FIG. 9, the data reading device 650 includes a window 658, and is adapted to receive an infrared signal from the portable data storage device 660 through the window 658.

The data reading devices 550 and 650 are adapted to remotely interface with the respective portable data storage devices 560 and 600. “Physical” and “remote” interface refer generally to the interface of the data reading device and the portable data storage device, and not necessarily to the relationship between the data reading means included in the data reading device, and the data storage medium included in the portable data storage device. For instance, if the portable data storage device uses an optical storage medium, and the data reading device uses a laser diode to read the optical storage medium, the laser diode will typically not touch the optical storage medium, even if the portable data storage device is inserted within, or otherwise physically interfaces with, the data reading device.

As with the data reading devices 50, 150, 250, 350 and 450, the data reading devices 550 and 650 can be formed, or modified, to be integral within, or separate form, a component of the telephone equipment.

These and other variations, modification and adaptations are all possible within the scope of the present invention.

We claim:

1. A packet-switched network telephone system, the system comprising:
at least one set of telephone equipment adapted for connection with a packet-switched network and for electronic registration upon connection;
wherein the electronic registration is based on registration information stored on a portable data storage device.

2. The system of claim 1, wherein the at least one set of telephone equipment includes a data reading device for obtaining the registration information from the portable data storage device.

3. The system of claim 2, wherein the data reading device is integral with at least one component of the at least one set of telephone equipment.

4. The system of claim 2, wherein the at least one set of telephone equipment includes a telephone adapted for connection with the packet-switched network, and the data reading device communicates the registration information to the telephone.

5. The system of claim 2, wherein the at least one set of telephone equipment includes a digital phone adapter adapted for connection with the packet-switched network, and the data reading device communicates the registration information to the digital phone adapter.

6. The system of claim 1, wherein the system further comprises a system server adapted to receive the electronic registration.

7. The system of claim 6, wherein the system server is adapted to associate a telephone number with the at least one set of telephone equipment based on the electronic registration.

8. The system of claim 6, wherein the system server is adapted to associate a billing account with the at least one set of telephone equipment based on the electronic registration.

9. The system of claim 6, wherein the system server is adapted to associate a voice mail box with the at least one set of telephone equipment based on the electronic registration.

10. A portable data storage device for use with a packet-switched network telephone system, the portable data storage device comprising:
a data storage medium adapted to store registration information.

11. The portable data storage device of claim 10, wherein the data storage medium has the registration information stored thereon, and the registration information includes a network address associated with a telephone number.

12. The portable data storage device of claim 10, wherein the portable data storage device is adapted to physically interface with a data reading device.

13. The portable data storage device of claim 10, wherein the portable data storage device is adapted to remotely interface with a data reading device.

14. A data reading device comprising:
a data reading means for obtaining registration information from a portable data storage device; and
a data communication means for communicating the registration information in connection with at least one set of telephone equipment adapted for connection with a packet-switched network.

15. The data reading device of claim 14, wherein the data reading device is adapted for integration with at least one component of the at least one set of telephone equipment.

16. The data reading device of claim 14, wherein the data reading device is adapted to separately connect with at least one component of the at least one set of telephone equipment.

17. The data reading device of claim 14, wherein the data reading device is adapted to obtain respective registration information from each of a plurality of portable data storage devices and further includes a selection means for selecting the respective registration information from one of the plurality of portable storage devices to be associated with an outgoing call.

18. The data reading device of claim 14, wherein the communicated registration information is communicated to the at least one set of telephone equipment.

19. The data reading device of claim 14, wherein the communicated registration information is used to replace at least a portion of registration information from the at least one set of telephone equipment.

20. The data reading device of claim 14, wherein the data reading means includes and RFID reader.
